(19) United States
(12) Patent Application Publication
(10) Pub. No.: US 2026/0287084 A1
(43) Pub. Date: Sep. 24, 2026

(54) METHOD FOR FAULT RECOGNITION FOR A VALVE ARRANGEMENT COMPRISING MULTIPLE SOLENOID VALVES IN A VEHICLE

(71) Applicant: AUMOVIO Germany GmbH, Frankfurt am Main (DE)

(72) Inventor: Christoph Löffler, Nürnberg (DE)

(73) Assignee: AUMOVIO Germany GmbH, Frankfurt am Main (DE)

(21) Appl. No.: 19/570,552

(22) Filed: Mar. 18, 2026

(30) Foreign Application Priority Data
Mar. 18, 2025 (DE) 10 2025 110 360.7

(51) Int. Cl. F16K 37/00; F16K 31/06

(52) U.S. Cl. CPC F16K 37/0025; F16K 31/0675

(57) ABSTRACT

A method for fault recognition for a valve arrangement comprising multiple solenoid valves in a vehicle comprises determining the valve coil resistance for each valve coil of the at least two solenoid valves of the valve arrangement, comparing the valve coil resistance of the first solenoid valve with a reference value, wherein the reference value is formed from at least one of the determined valve coil resistances, and recognizing a faulty solenoid valve by means of the control unit if a difference between the valve coil resistance of the first solenoid valve to be tested and the reference value exceeds a threshold value.

### TECHNICAL FIELD

The invention relates to a method for fault recognition for a valve arrangement with multiple solenoid valves in a vehicle.

### BACKGROUND

Electric solenoid valves have been known in vehicle construction for decades and are used in brake systems and in chassis control, for example for adaptation of damping behavior.

Solenoid valves are an inductive load in an electrical circuit which reacts to a voltage change in a delayed manner and has the known follow-up behavior and the inducing of a countervoltage also when the supply voltage is disconnected.

It should furthermore be taken into consideration that the solenoid valve is often used in a highly dynamic working environment which, on the one hand, requires fast reaching and maintaining of a desired position of the solenoid valve and, on the other hand, is exposed to considerable fluctuating loads by the valve-controlled working medium, so that the solenoid valve is exposed to impulses which are induced in the working medium by these changes and which in turn have to be compensated for by the electrical control.

It is an objective to provide a method for fault recognition for a valve arrangement comprising multiple solenoid valves in a vehicle, which method can firstly be carried out in a cost-effective manner and secondly can perform a test of the functionality of the solenoid valves after installation in a vehicle.

### SUMMARY

To achieve the object, a method for fault recognition for a valve arrangement comprising multiple solenoid valves in a vehicle is provided. The valve arrangement comprises at least two solenoid valves. Each solenoid valve has a valve coil with a valve coil resistance. The valve arrangement is connected in signal-transmitting manner to a control unit for controlling the solenoid valves. The method comprises the following steps: determining the valve coil resistance for each valve coil of the at least two solenoid valves of the valve arrangement, comparing the valve coil resistance of the first solenoid valve with a reference value, wherein the reference value is formed from at least one of the determined valve coil resistances, and recognizing a faulty solenoid valve by means of the control unit if a difference between the valve coil resistance of the first solenoid valve to be tested and the reference value exceeds a threshold value.

A valve arrangement is to be understood to mean an arrangement of at least two solenoid valves which are for example installed in a chassis and which are connected in a signal-transmitting manner to a control unit. In addition, the solenoid valves may be connected to a pump which delivers fluid to the solenoid valves via fluid lines. As a result of the signal-enabled control of a solenoid valve by means of the control unit, it is possible, for example, to change the damping behavior of the chassis of the vehicle by virtue of fluid being conducted into or out of a damper.

A solenoid valve is to be understood to mean valves which are actuated by controlling an electromagnet. In this case, the electromagnet comprises a valve coil which is formed from a plurality of coils of a copper wire, for example. If the valve coil is supplied with a voltage and a current flows through the windings, then a magnetic field is built up, as is generally known. An armature situated in the solenoid valve is drawn in the direction of the valve coil by means of said magnetic field. If the coil is de-energized, the magnetic field dissipates again and the armature is moved away from the coil again by a spring.

A valve coil is to be understood to mean the coil situated in a solenoid valve, which coil comprises a plurality of windings made of an electrical conductor, for example copper. The strength of the magnetic field generated by the valve coil can be varied by means of the number of windings. The valve coil has a valve coil resistance.

The valve coil resistance is understood to be the ohmic resistance of the valve coil of the solenoid valve, which results from the ohmic resistance of the electrical conductor. The valve coil resistance is determined using the known formula R=U/I.

A control unit is to be understood to mean any type of computer-aided computing unit which can perform calculations and/or generate control commands. A control unit may be for example a high-performance computer or microcontroller.

A reference value is understood to mean a defined value which is used for the comparison with a determined value. The reference value is formed, for example, from at least one of the determined valve coil resistances of the at least two solenoid valves in the valve arrangement.

A threshold value is understood to be a limiting value at which a solenoid valve is detected as faulty or declared to be faulty. The threshold value may for example comprise an upper threshold value and a lower threshold value. The upper threshold value lies, for example, 10-20% above the determined reference value. The lower threshold value lies, for example, 10-20% below the determined reference value.

Therefore, a faulty solenoid valve of the valve arrangement of the vehicle can be recognized even if it is already installed in the chassis of the vehicle.

The reference value may be formed from the mean value of all determined valve coil resistances of the at least two solenoid valves of the valve arrangement. The mean value corresponds, for example, to the arithmetic mean value, wherein all the valve coil resistances except the valve coil resistance of the first solenoid valve are summed and divided by the number of summed solenoid valves. Thus, the reference value takes manufacturing tolerances and/or environmental influences into account.

Furthermore, the reference value may be the determined valve coil resistance of a solenoid valve from the multiple solenoid valves of the valve arrangement, wherein the reference value does not comprise the valve coil resistance of the first solenoid valve to be tested. The one solenoid valve is not identical to the first solenoid valve, so that it is for example the second solenoid valve. Thus, the valve coil resistance of the first solenoid valve that is to be tested is compared only with valve coil resistances of the other solenoid valves.

In addition, the comparison of the valve coil resistance of the first solenoid valve with the reference value and the recognition of the faulty solenoid valve can be carried out for all the further solenoid valves of the valve arrangement, for example, in succession. For example, the comparison and recognition can be carried out for the second solenoid valve. Thus, all solenoid valves of the valve arrangement are tested for their functionality.

The valve arrangement may comprise four solenoid valves, wherein the valve coil resistance can be determined for each of the four solenoid valves. Each of the four solenoid valves is connected in a signal-transmitting manner to the control unit by means of a cable, wherein the control unit can transmit control signals for the control of each solenoid valve to each solenoid valve. Each of the four solenoid valves is comprised in the damper of the chassis. Thus, the damping of each damper of the chassis can be separately adjusted individually.

Furthermore, the determined valve coil resistance of the first solenoid valve can be compared with the valve coil resistances of the second solenoid valve and/or of the third solenoid valve and/or of the fourth solenoid valve. The comparison is carried out, for example, by means of the control unit. The first solenoid valve is connected to the control unit for signaling purposes by means of a first cable. The second solenoid valve is connected to the control unit for signaling purposes by means of a second cable. The third solenoid valve is connected to the control unit for signaling purposes by means of a third cable. The fourth solenoid valve is connected to the control unit for signaling purposes by means of a fourth cable. The comparison with the respective other solenoid valves of the valve arrangement can be carried out, for example, for the second solenoid valve, the third solenoid valve and the fourth solenoid valve. Thus, environmental influences and/or manufacturing tolerances of a solenoid valve can be better taken into account during the comparison.

Furthermore, the valve arrangement may comprise eight solenoid valves, wherein the valve coil resistance is determined for each of the eight solenoid valves. Each of the eight solenoid valves is connected in a signal-transmitting manner to the control unit by means of a cable, wherein the control unit can transmit control signals for the control of each solenoid valve to each solenoid valve. In each case two solenoid valves of the eight solenoid valves are comprised in the damper of the chassis. Thus, the damping of each damper of the chassis can be separately adjusted individually.

Each of the eight valve coil resistances determined can be compared with the other valve coil resistances. For example, the determined valve coil resistance of the first solenoid valve can be compared with the valve coil resistances of the second solenoid valve and/or of the third solenoid valve and/or of the fourth solenoid valve and/or of the fifth solenoid valve and/or of the sixth solenoid valve and/or of the seventh solenoid valve and/or of the eighth solenoid valve. The first solenoid valve is connected to the control unit for signaling purposes by means of a first cable. The second solenoid valve is connected to the control unit for signaling purposes by means of a second cable. The third solenoid valve is connected to the control unit for signaling purposes by means of a third cable. The fourth solenoid valve is connected to the control unit for signaling purposes by means of a fourth cable. The fifth solenoid valve is connected to the control unit for signaling purposes by means of a fifth cable. The sixth solenoid valve is connected to the control unit for signaling purposes by means of a sixth cable. The seventh solenoid valve is connected to the control unit for signaling purposes by means of a seventh cable. The eighth solenoid valve is connected to the control unit for signaling purposes by means of a eighth cable. The comparison can be carried out for example, for the second solenoid valve, the third solenoid valve, the fourth solenoid valve, the fifth solenoid valve, the sixth solenoid valve, the seventh solenoid valve and the eighth solenoid valve with the respective other solenoid valves of the valve arrangement. This has the advantage that environmental influences and/or manufacturing tolerances of a solenoid valve can be better taken into account during the comparison.

Furthermore, the valve coil resistances can be determined and compared and faulty solenoid valves can be recognized during a starting process of the vehicle. The starting process of the vehicle is, for example, a first-time start-up of systems of the vehicle which is preceded by a phase of a standstill of the vehicle, for example after the vehicle has been parked in a garage overnight and is started the next morning. The starting process is started, for example, by operation of a starting device, for example a start-stop button or an ignition. Thus, the determining of the valve coil resistances, the comparing and the determining of a faulty solenoid valve take place with greater accuracy.

### BRIEF DESCRIPTION OF THE DRAWINGS

Further features can be found in the following description in conjunction with the appended drawings. In the figures:

FIG. 1 shows a flow diagram of the method for fault recognition for a valve arrangement comprising multiple solenoid valves provided in a vehicle;

### DETAILED DESCRIPTION

Solenoid valves are used in many areas in which fluids have to be conveyed to or away from consumers. One application is in a chassis of a vehicle, for example in dampers of the chassis. Here, the solenoid valves are used in the dampers for setting the damping behavior of the chassis. Each of the four solenoid valves is connected in a signal-transmitting manner to a control unit.

In one exemplary embodiment, the vehicle comprises four solenoid valves, wherein in each case one solenoid valve is comprised in one damper. The damper comprises a cylinder, in which the fluid is contained, and a piston, which is arranged movably in the cylinder. The piston projects on a first side of the cylinder and comprises a first fastening device which is mounted, for example, on a body. The cylinder is mounted, on a second side, situated opposite the first side, for example on a wheel or a wheel suspension arrangement by means of a second fastening device. If, for example, a shock is exerted on the wheel on account of a pothole, the cylinder moves in the direction of the first fastening device. Here, fluid, in particular oil, is forced from a first chamber into a second chamber by means of the solenoid valves. As a result of the movement of the piston in the fluid, the shock is converted into heat. If the chassis is supposed to have more intense damping, a flow of the fluid through the solenoid valve is limited or prevented entirely. As a result of the complete closure of the solenoid valve in the damper, the flow rate of the fluid is substantially equal to zero, whereby the exchange of the fluid from the first chamber to the second chamber is limited. In the closed state, the damping has the greatest effect, i.e., hard behavior. A partial opening of the solenoid valve results in an increase in the flow rate of the fluid. When the solenoid valve is completely opened, the flow rate of the fluid is at its greatest, for which reason the damping has the least effect, that is to say soft behavior, in this state.

The opening of the solenoid valve is performed by means of the valve coil. A current is applied to the valve coil and generates a magnetic field which pulls an armature, located in the solenoid valve, in the direction of the valve coil. If the valve coil is not supplied with current, the armature is moved by a spring into its initial position, which corresponds to the closed state. If the valve coil is supplied with maximum current, the armature is thus deflected fully in the direction of the valve coil and is situated in the fully open state. If the valve coil is supplied with a current between zero and a maximum current, the armature is correspondingly deflected between the closed state and the fully open state.

The valve coil has a valve coil resistance. The valve coil resistance may decrease owing to environmental influences and/or aging effects, for which reason the magnetic field strength of the valve coil decreases and possibly the armature is not deflected into the desired position by the valve coil. As soon as the solenoid valve can for example no longer fully deflect the armature by means of the valve coil, the solenoid valve is faulty. For example, the entire damper would have to be replaced in order for the chassis to return to its full function.

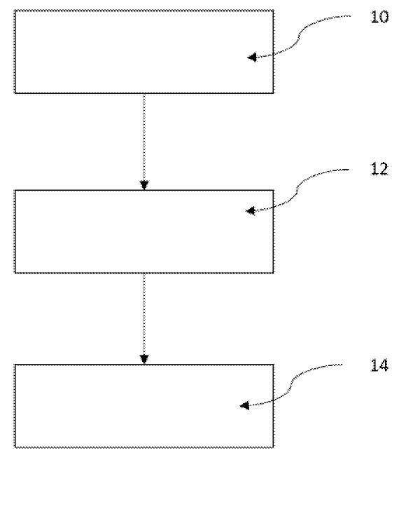

FIG. 1 illustrates a method for recognizing a faulty solenoid valve. The driver of the vehicle starts the vehicle by operating the ignition, for example a start-stop button. After the starting, the control unit begins, in a first step, the determination 10 of the valve coil resistances of the valve coils of the four solenoid valves. Once the valve coil resistance for the first solenoid valve, the second solenoid valve, the third solenoid valve and the fourth solenoid valve has been determined, the determined valve coil resistances may for example be stored in a memory unit. The first solenoid valve, the second solenoid valve, the third solenoid valve and the fourth solenoid valve are each connected to the control unit for signaling purposes by means of at least one line.

In a second step, the control unit firstly conducts a comparison 12 of the valve coil resistance of the first solenoid valve with the valve coil resistance of the second solenoid valve, wherein the valve coil resistance of the second solenoid valve serves as a reference value. If the valve coil resistance of the first solenoid valve deviates from the valve coil resistance of the second solenoid valve, for example by 10%, the control unit recognizes 14 the first solenoid valve as faulty. The deviation of 10%, for example, is in this case the threshold value which is referenced to the reference value.

If the threshold value is not exceeded when comparing the valve coil resistance of the first solenoid valve with the valve coil resistance of the second solenoid valve, the control unit compares the valve coil resistance of the first solenoid valve with the valve coil resistance of the third solenoid valve. If the valve coil resistance of the first solenoid valve deviates from the valve coil resistance of the third solenoid valve, for example by 10%, the control unit recognizes the first solenoid valve as faulty.

If the threshold value is not exceeded when comparing the valve coil resistance of the first solenoid valve with the valve coil resistance of the third solenoid valve, the control unit compares the valve coil resistance of the first solenoid valve with the valve coil resistance of the fourth solenoid valve. If the valve coil resistance of the first solenoid valve deviates from the valve coil resistance of the fourth solenoid valve, for example by 10%, the control unit recognizes the first solenoid valve as faulty.

If the threshold value is not exceeded when comparing the valve coil resistance of the first solenoid valve with the valve coil resistances of the second solenoid valve, of the third solenoid valve and of the fourth solenoid valve, then the first solenoid valve is functional or not faulty.

The control unit thereafter begins comparing the valve coil resistance of the second solenoid valve with the valve coil resistances of the first solenoid valve, of the third solenoid valve and of the fourth solenoid valve. The steps of comparing the valve coil resistances and recognizing a faulty solenoid valve are to be applied here correspondingly as discussed above.

The comparison of the valve coil resistances and the recognition of a faulty solenoid valve is carried out in succession for the first solenoid valve, the second solenoid valve, the third solenoid valve and the fourth solenoid valve.

The above-mentioned steps are identical in a further exemplary embodiment. Only the mean value of the remaining solenoid valves with which the first solenoid valve is compared serves as a reference value. If the first solenoid valve is compared with the second solenoid valve, the third solenoid valve and the fourth solenoid valve, the reference value is the mean value of the valve coil resistances of the second solenoid valve, of the third solenoid valve and of the fourth solenoid valve.

If the second solenoid valve is compared with the first solenoid valve, the third solenoid valve and the fourth solenoid valve, the reference value is the mean value of the valve coil resistances of the first solenoid valve, of the third solenoid valve and of the fourth solenoid valve.

What has been explained above is to be applied to the third solenoid valve and to the fourth solenoid valve when carrying out the method steps.

In a further exemplary embodiment, the vehicle comprises eight solenoid valves, wherein two solenoid valves are comprised in a damper. As explained in the first exemplary embodiment, the driver of the vehicle starts the vehicle by operating the ignition, for example a start-stop button. After the starting, the control unit begins, in a first step, the determination of the valve coil resistances of the valve coils of the eight solenoid valves. After the vehicle has been started, the valve coil resistances for the first solenoid valve, the second solenoid valve, the third solenoid valve, the fourth solenoid valve, the fifth solenoid valve, the sixth solenoid valve, the seventh solenoid valve and the eighth solenoid valve are determined. The determined valve coil resistances may for example be stored in a memory unit. The first solenoid valve, the second solenoid valve, the third solenoid valve, the fourth solenoid valve, the fifth solenoid valve, the sixth solenoid valve, the seventh solenoid valve and the eighth solenoid valve are each connected in a signal-transmitting manner to the control unit by means of at least one line.

In the second step, the control unit first compares the valve coil resistance of the first solenoid valve with the valve coil resistance of the second solenoid valve, as in the example discussed above. The valve coil resistance of the second solenoid valve serves as a reference value here too.

In a third step, the control unit determines a difference between the valve coil resistance of the first solenoid valve and the valve coil resistance of the second solenoid valve. If the difference exceeds a threshold value, for example by 10%, the control unit identifies the first solenoid valve as faulty.

The second step and the third step are carried out in the same way for the third solenoid valve, the fourth solenoid valve, the fifth solenoid valve, the sixth solenoid valve, the seventh solenoid valve and the eighth solenoid valve. If, when comparing the valve coil resistance of the first solenoid valve with the other valve coil resistances of the remaining solenoid valves, the threshold value is exceeded, the first solenoid valve is determined by the control unit to be non-functional or faulty. If, in all comparisons, the valve coil resistance of the first solenoid valve with the other valve coil resistances of the remaining solenoid valves is not exceeded, the first solenoid valve is functional or not faulty.

The above-mentioned steps are identical in a further exemplary embodiment. Only the mean value of the remaining solenoid valves with which the first solenoid valve is compared serves as a reference value. When the first solenoid valve is compared with the second solenoid valve, the third solenoid valve, the fourth solenoid valve, the fifth solenoid valve, the sixth solenoid valve, the seventh solenoid valve, and the eighth solenoid valve, the reference value is the mean value of the valve coil resistances of the second solenoid valve, the third solenoid valve, the fourth solenoid valve, the fifth solenoid valve, the sixth solenoid valve, the seventh solenoid valve, and the eighth solenoid valve.

If the second solenoid valve is compared with the first solenoid valve, the third solenoid valve, the fourth solenoid valve, the fifth solenoid valve, the sixth solenoid valve, the seventh solenoid valve and the eighth solenoid valve, the reference value is the mean value of the valve coil resistances of the first solenoid valve, of the third solenoid valve, of the fourth solenoid valve, of the fifth solenoid valve, of the sixth solenoid valve, of the seventh solenoid valve and the eighth solenoid valve.

When carrying out the method steps, that which has been discussed above is applicable to the third solenoid valve, the fourth solenoid valve, the fifth solenoid valve, the sixth solenoid valve, the seventh solenoid valve and the eighth solenoid valve.

The steps can be carried out as follows in a further exemplary embodiment. Determining the valve coil resistances of all solenoid valves of the valve arrangement. Ordering the determined valve coil resistances. Comparing the determined valve coil resistances with one another, wherein a coefficient of two measured valve coil resistances is formed for the comparison. The solenoid valves are functional if the coefficient is greater than a threshold value. The solenoid valves are not functional, if the coefficient is less than the threshold value, comparison begins afresh, wherein the comparison is carried out once without the largest determined valve coil resistance and once without the smallest determined valve coil resistance. The other solenoid valves are functional if the coefficient is greater than the threshold value, and the solenoid valve that has been omitted in the comparison is not functional

The valve coil resistances are determined in a known manner.

The subsequent ordering of the determined valve coil resistances is preferably performed by means of the control unit. The valve coil resistances may for example be ordered in ascending order of the determined values.

In the comparison, the largest determined valve coil resistance is compared with the lowest determined valve coil resistance by forming a coefficient of these two values. The coefficient is the quotient of the smallest determined valve coil resistance divided by the largest determined valve coil resistance. If the coefficient approaches the value of zero, the two valve coil resistances lie far apart. If the coefficient approaches the value of one, the two valve coil resistances are similar or substantially the same.

All solenoid valves of the valve arrangement are recognized as being functional if the determined coefficient is higher than a threshold value. The threshold value may be, for example, between 0.7 and 1.0.

If the determined coefficient is below the threshold value, a new coefficient is determined. In determining the new coefficient, firstly the largest valve coil resistance determined and then the lowest valve coil resistance determined are omitted. As a result, the next higher or next lower valve coil resistance is used for determining the new coefficient. If the largest determined valve coil resistance is omitted in the exemplary embodiment with four solenoid valves, three solenoid valves in which the solenoid valve with the smallest determined valve coil resistance is comprised remain. Here, as described above, the new coefficient is formed. Subsequently, the largest valve coil resistance is added to determine the new coefficient, and the lowest valve coil resistance is omitted. The new coefficient is thus formed for three solenoid valves that comprise the largest determined valve coil resistance.

If the valve coil resistance lies above the new coefficient, the remaining solenoid valves are functional. The solenoid valve that is not taken into account or omitted in the formation of the new coefficient, that is to say either that with the highest or lowest determined valve coil resistance, is accordingly not functional.

1. A method for fault recognition for a valve arrangement with multiple solenoid valves in a vehicle comprising:
determining with a control unit a valve coil resistance for each valve coil of at least two solenoid valves of the valve arrangement;
comparing the valve coil resistance of the first solenoid valve with a reference value, wherein the reference value is formed from at least one of the determined valve coil resistances; and
recognizing a faulty solenoid valve with the control unit when a difference between the valve coil resistance of the first solenoid valve to be tested and the reference value exceeds a threshold value.

2. The method according to claim 1, further comprising forming the reference value from the mean value of all determined valve coil resistances of the at least two solenoid valves of the valve arrangement.

3. The method according to claim 1, wherein the reference value is the determined valve coil resistance of a solenoid valve from the multiple solenoid valves of the valve arrangement, wherein the reference value does not comprise the determined valve coil resistance of the first solenoid valve to be tested.

4. The method according to claim 1, wherein comparing the valve coil resistances with the reference value and recognizing the faulty solenoid valve is carried out for all solenoid valves of the valve arrangement in succession.

5. The method according to claim 1, wherein the valve arrangement comprises four solenoid valves, wherein the valve coil resistance is determined for each of the four solenoid valves.

6. The method according to claim 5, wherein the determined valve coil resistance of the first solenoid valve is compared with the valve coil resistances of at least one of the second solenoid valve, the third solenoid valve, and the fourth solenoid valve.

7. The method according to claim 1, wherein the valve arrangement comprises eight solenoid valves, wherein the valve coil resistance is determined for each of the eight solenoid valves.

8. The method according to claim 7, wherein each of the eight determined valve coil resistances is compared with the other valve coil resistances.

9. The method according to claim 1, wherein the determining and comparing of the valve coil resistances and the recognizing of faulty solenoid valves takes place during a starting process of the vehicle.
